(19) United States
(12) Patent Application Publication
(10) Pub. No.: US 2026/0149163 A1
(43) Pub. Date: May 28, 2026

(54) VEHICLE WINDOW GLASS

(71) Applicant: AGC Inc., Tokyo (JP)

(72) Inventors: Atsutoshi Nakata, Tokyo (JP); Eita Umezawa, Tokyo (JP)

(73) Assignee: AGC Inc., Tokyo (JP)

(21) Appl. No.: 19/396,086

(22) Filed: Nov. 20, 2025

(30) Foreign Application Priority Data
Nov. 25, 2024 (JP) 2024-204763

(51) Int. Cl. H01Q 1/12; B60J 1/20; H01Q 7/00

(52) U.S. Cl. CPC H01Q 1/1271; B60J 1/20; H01Q 7/00

(57) ABSTRACT

A vehicle window glass of the present invention includes a glass plate and an antenna. The antenna includes a feeding portion and an antenna element. The antenna element includes a first vertical element, a first loop element, and a first folded-back element. The first vertical element is electrically connected to the feeding portion and extends in the vertical direction. The first loop element is connected to the first vertical element to have a loop shape and is provided on one side in the horizontal direction with respect to the first vertical element. The first folded-back element is connected to the first vertical element and extends toward the other side in the horizontal direction with respect to the first vertical element to have a folded-back shape.

### CROSS-REFERENCE TO RELATED APPLICATION

This application claims priority from Japanese Patent Application No. 2024-204763, filed Nov. 25, 2024, the content of which is incorporated herein by reference in their entirety.

### BACKGROUND OF THE INVENTION

### Field of the Invention

The present invention relates to a vehicle window glass.

### Description of Related Art

Automobiles in recent years have had window glass on which an antenna is formed. This antenna can receive radio waves in various frequency bands such as AM broadcast waves, FM broadcast waves, digital audio broadcasting (DAB) Band III of the European standard, and terrestrial digital broadcast waves.

An antenna formed in an opening of the window glass in this way has a pattern formed to obtain a predetermined reception sensitivity according to an area of the opening of the window glass. For example, a defogger having an electric heating wire for heating a glass is disposed on a rear glass of an automobile for anti-fogging and anti-icing purposes. In a region of the opening that is different from the defogger region, an antenna pattern is formed to obtain a predetermined sensitivity for radio waves in a predetermined frequency band.

Japanese Patent No. 5141500 (hereinafter, referred to as Patent Document 1) below discloses an example in which a first broadcast frequency band and a desired second broadcast frequency band, which has a higher frequency band than the first broadcast frequency band, can be received.

However, when various antennas are concentrated on a glass plate as in the technology disclosed in Patent Document 1, a region in which antenna elements can be disposed is limited due to space constraints, and there have been cases in which a reception gain in a predetermined frequency band cannot always be increased.

### SUMMARY OF THE INVENTION

The present invention provides a vehicle window glass capable of receiving radio waves in a predetermined frequency band with a desired gain using an antenna pattern different from conventional antenna patterns formed on glass plates.

In order to solve the above-described problem, the present invention has the following configuration.

A vehicle window glass according to one aspect of the present invention includes a glass plate, and an antenna formed on the glass plate and capable of receiving radio waves of a predetermined frequency band. The antenna includes a feeding portion, and an antenna element electrically connected to the feeding portion. When a direction parallel to a horizontal plane is defined as a horizontal direction, and a direction perpendicular to the horizontal direction is defined as a vertical direction in a plan view in a state in which the glass plate is attached to a window frame, the antenna element includes a first vertical element electrically connected to the feeding portion and extending in the vertical direction, a first loop element connected to the first vertical element to have a loop shape and provided on one side in the horizontal direction with respect to the first vertical element, and a first folded-back element connected to the first vertical element and extending toward the other side in the horizontal direction with respect to the first vertical element to have a folded-back shape.

In the vehicle window glass according to one aspect of the present invention, the first loop element may include a first element extending from the first vertical element to one side in the horizontal direction, a second element extending from an end part of the first element on one side in the horizontal direction to one side in the vertical direction away from the feeding portion, and a third element extending from an end part of the second element on one side in the vertical direction to the other side in the horizontal direction to be connected to the first vertical element.

In the vehicle window glass according to one aspect of the present invention, the third element may be connected to an end part of the first vertical element on one side in the vertical direction.

In the vehicle window glass according to one aspect of the present invention, the first folded-back element may be connected to a contact point between the first vertical element and the third element.

In the vehicle window glass according to one aspect of the present invention, the first folded-back element may include a fourth element extending from the first vertical element to the other side in the horizontal direction, a fifth element extending from an end part of the fourth element on the other side in the horizontal direction to the other side in the vertical direction close to the feeding portion, and a sixth element extending from an end part of the fifth element on the other side in the vertical direction to one side in the horizontal direction.

In the vehicle window glass according to one aspect of the present invention, the first folded-back element may include a seventh element extending from an end part of the sixth element on one side in the horizontal direction to the other side in the vertical direction, and an eighth element extending from an end part of the seventh element on the other side in the vertical direction to the other side in the horizontal direction.

In the vehicle window glass according to one aspect of the present invention, the first folded-back element may include a ninth element extending from the first vertical element to the other side in the horizontal direction, a tenth element extending from an end part of the ninth element on the other side in the horizontal direction, in an elevation-angle direction extending so as to approach the feeding portion in the vertical direction with an increase in distance from the first vertical element, an eleventh element extending from an end part of the tenth element in the elevation-angle direction to the other side in the vertical direction or to one side in the horizontal direction, a twelfth element extending from an end part of the eleventh element on the other side in the vertical direction or on one side in the horizontal direction, in a depression-angle direction extending away from the feeding portion in the vertical direction with a decrease in distance from the first vertical element, and a thirteenth element extending from an end part of the twelfth element in the depression-angle direction to one side in the horizontal direction.

The vehicle window glass according to one aspect of the present invention may include a lead-out element extending in the horizontal direction from the feeding portion, and the first vertical element may be connected to the lead-out element.

The vehicle window glass according to one aspect of the present invention may include a second loop element connected to the first vertical element to have a loop shape and provided on the other side in the horizontal direction with respect to the first vertical element.

The vehicle window glass according to one aspect of the present invention may include a second folded-back element connected to the first folded-back element and having a folded-back shape in the vertical direction.

In the vehicle window glass according to one aspect of the present invention, the antenna may be capable of receiving, as radio waves of the predetermined frequency band, radio waves of a first frequency band and radio waves of a second frequency band higher than the first frequency band.

In the vehicle window glass according to one aspect of the present invention, the first frequency band may be a frequency band of FM broadcast waves.

In the vehicle window glass according to one aspect of the present invention, the second frequency band may be a frequency band of Band III of the DAB standard.

According to the present invention, radio waves in a predetermined frequency band can be received with a desired gain using an antenna pattern different from conventional antenna patterns formed on glass plates.

### BRIEF DESCRIPTION OF THE DRAWINGS

FIG. 1 is a plan view showing a vehicle window glass according to a first embodiment of the present invention.

FIG. 2 is an enlarged plan view showing an antenna according to the first embodiment of the present invention.

FIG. 3 is an enlarged plan view showing an antenna according to a second embodiment of the present invention.

FIG. 4 is an enlarged plan view showing an antenna according to a third embodiment of the present invention.

FIG. 5 is an enlarged plan view showing an antenna according to a fourth embodiment of the present invention.

FIG. 6 is an enlarged plan view showing an antenna according to a fifth embodiment of the present invention.

FIG. 7 is an enlarged plan view showing an antenna according to a sixth embodiment of the present invention.

FIG. 8 is an enlarged plan view showing an antenna according to a seventh embodiment of the present invention.

FIG. 9 is an enlarged plan view showing an antenna according to an eighth embodiment of the present invention.

FIG. 10 is a plan view showing a vehicle window glass according to one example of the present invention.

FIG. 11 is a graph showing actual measurement results of antenna gains in a predetermined frequency band of the vehicle window glass according to one example of the present invention.

FIG. 12 is a graph showing actual measurement results of antenna gains in a predetermined frequency band of the vehicle window glass according to one example of the present invention.

### DETAILED DESCRIPTION OF THE INVENTION

Hereinafter, a vehicle window glass according to an embodiment of the present invention will be described in detail with reference to the drawings. Note that, for ease of understanding, scales of each of portions in the drawings may be different from actual ones. In directions such as parallel, perpendicular, orthogonal, horizontal, vertical, upward and downward, and leftward and rightward, an error to an extent that effects of the embodiment are not impaired is allowed. A shape of a corner is not limited to a right angle and may be rounded with an arcuate shape. Parallel, perpendicular, orthogonal, horizontal, and vertical may include substantially parallel, substantially perpendicular, substantially orthogonal, substantially horizontal, and substantially vertical. Particularly, although a shape of an antenna element to be described later is shown as a straight line in the drawings, it is not limited to a straight line and may be curved with an arcuate shape.

Also, hereinafter, in a plan view in a state in which the vehicle window glass is attached to a window frame, a direction parallel to a horizontal plane is defined as a horizontal direction, and a direction orthogonal to the horizontal direction is defined as a vertical direction. Also, the horizontal direction and the vertical direction each have two opposing orientations, and when indicating one of the two opposing orientations, they are defined as a first direction, a second direction, a third direction, and a fourth direction. Note that, a relationship between the horizontal direction and the vertical direction, and the first direction, the second direction, the third direction, and the fourth direction is defined in each embodiment. Also, “to” indicating a numerical range means that numerical values stated before and after “to” are included as a lower limit value and an upper limit value.

Also, in description of each component of the antenna (such as a feeding portion or an antenna element), when the term “connection” is simply used, it means both physical and electrical connection. Particularly, when the phrase “electrically connected” is used, it only need to be at least electrical connection and does not require a physical connection. For example, when an element A and an element B are “electrically connected,” an element C that physically and electrically connects element A and element B may be interposed. That is, when the phrase “electrically connected” is used, the element A and the element B do not need to be physically connected directly.

Furthermore, in the following description, an example in which the vehicle window glass according to the embodiment of the present invention is applied to a rear glass at a rear part of a vehicle will be described, but it is applicable to a windshield (front glass) at a front part of the vehicle or a side window at a side part of the vehicle.

### First Embodiment

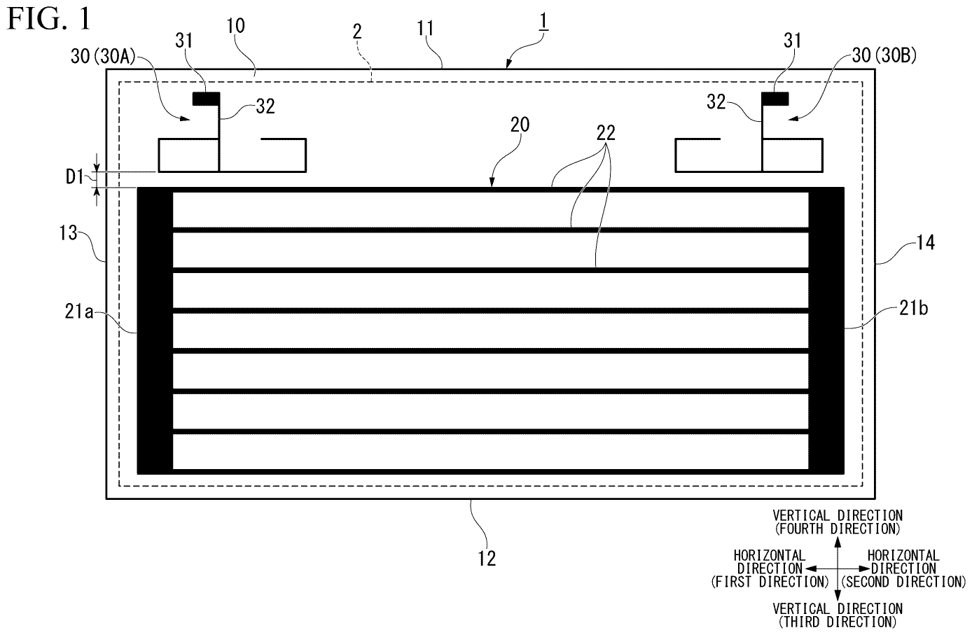

FIG. 1 is a plan view showing a vehicle window glass 1 according to a first embodiment of the present invention. The vehicle window glass 1 shown in FIG. 1 is attached to a window frame 2 at a rear part of a vehicle body. Note that, in FIG. 1, an opening of the window frame 2 is indicated by a dotted line. Also, in FIG. 1, the vehicle window glass 1 in a state of being attached to the window frame 2 is shown as viewed from the inside of the vehicle (a view from inside the vehicle). In FIG. 1, on an outer side of the opening indicated by the dotted line, a circumferential edge portion of a main surface of a glass plate 10 and the window frame 2 which is a flange serving as a metal portion are attached to each other with an adhesive such as a urethane resin (not shown in the drawings). Note that, the glass plate 10 may have a light-shielding layer of a predetermined width formed on a circumferential edge portion of a surface on a vehicle interior side, the light-shielding layer being formed of a color ceramic layer in black, a dark color, or other colors such as white, a color ink layer printed with an organic ink or an inorganic ink, or the like. The glass plate 10 is attached to the window frame 2 by an adhesive applied to the light-shielding layer. Note that, when the light-shielding layer is a color ceramic layer, the light-shielding layer is formed by printing a ceramic paste containing glass frit and a black or dark color pigment by screen printing or the like, and then firing the printed ceramic paste.

As shown in FIG. 1, the vehicle window glass 1 of the present embodiment includes the glass plate 10, a defogger 20, and an antenna 30. The defogger 20 and the antenna 30 are formed by, for example, printing and firing a silver paste containing silver powder and glass frit on a surface on the vehicle interior side of the glass plate 10. However, the antenna 30 may be formed of a conductive material such as copper on a transparent resin film and may be attached to a surface on the vehicle interior side of the glass plate 10. Note that, if the vehicle window glass 1 is a window glass other than a rear glass, the defogger 20 is not essential. The glass plate 10 has a substantially quadrangular outer shape in a plan view. When the glass plate 10 is attached to the window frame 2, an outer edge of the glass plate 10 includes an upper edge 11 and a lower edge 12 facing each other in the vertical direction and a left edge 13 and a right edge 14 facing each other in the horizontal direction.

The vehicle window glass 1 is manufactured by printing a ceramic paste on the glass plate 10 and drying it to form a color ceramic paste coating film, and then printing a silver paste and drying it to form a silver paste coating film. Thereafter, the glass plate 10 may be heated to 600 to 700° C. to fire the color ceramic paste coating film and the silver paste coating film, thereby forming the light-shielding layer, the defogger 20, and the antenna 30. During heating of the glass plate 10, the glass plate 10 may be formed to be bent into a predetermined shape. As a method for bending formation, a known method such as press forming and gravity forming can be used. Also, if the glass plate 10 is a rear glass, the glass plate 10 may be heated to 600 to 700° C. and then rapidly cooled to 300° C. or lower to form tempered glass.

The defogger 20 is a conductive pattern provided on the glass plate 10. The defogger 20 shown in FIG. 1 is an electric-heating-type defogger. The defogger 20 includes a first bus bar 21a, a second bus bar 21b, and a plurality of heater wires 22. The first bus bar 21a and the second bus bar 21b are a pair of bus bars that extend in the vertical direction. The plurality of heater wires 22 are disposed between the first bus bar 21a and the second bus bar 21b. The plurality of heater wires 22 extend in the horizontal direction. Note that, the defogger 20 may include a short-circuit wire which is not shown in the drawings and extends in the vertical direction and short-circuits at least a part of the plurality of heater wires 22.

The heater wires 22 are disposed between the first bus bar 21a and the second bus bar 21b. A voltage (DC voltage) is applied to the heater wires 22 via the first bus bar 21a and the second bus bar 21b. Therefore, the heater wires 22 heat the glass plate 10. When the glass plate 10 is heated, condensation (fogging) on the glass plate 10 is removed.

The first bus bar 21a and the second bus bar 21b are disposed at both end sides of the glass plate 10 in the horizontal direction. The first bus bar 21a extends in the vertical direction along the left edge 13 of the glass plate 10. The second bus bar 21b extends in the vertical direction along the right edge 14 of the glass plate 10. The first bus bar 21a and the second bus bar 21b supply power to the plurality of heater wires 22 extending in the horizontal direction to run parallel to each other. Note that, the number of the heater wires 22 is not particularly limited. Note that, it is preferable that the first bus bar 21a and the second bus bar 21b be formed on the light-shielding layer.

The antenna 30 is configured to receive radio waves in a predetermined frequency band. The antenna 30 is configured to receive radio waves in two different frequency bands. The two different frequency bands may be a combination of frequency bands that partially overlap, or may be a combination of frequency bands that do not overlap at all. In the following description, unless otherwise specified, the antenna 30 is configured to receive radio waves in two different frequency bands as the radio waves of the predetermined frequency band. The antenna 30 resonates at frequencies in the two different frequency bands. The same applies to each antenna in the second embodiment and subsequent embodiments in the present specification. For example, the antenna 30 is capable of receiving radio waves of a VHF band (30 MHz to 300 MHz).

The antenna 30 of the present embodiment receives, as the radio waves in the VHF band, radio waves of, for example, FM broadcast waves (76 MHz to 108 MHz). Furthermore, the antenna 30 of the present embodiment receives, as the radio waves in the VHF band, radio waves of, for example, Band III (174 MHz to 240 MHz) of the DAB standard. Note that, the antenna 30 may receive radio waves in DTV waves (470 MHz to 710 MHz) as a UHF band (300 MHz to 3 GHz), radio waves in AM broadcast waves (522 kHz to 1710 kHz) as an MF band, or the like.

The antenna 30 is a glass antenna provided on the glass plate 10. The antenna 30 is disposed in a region above the defogger 20 when the glass plate 10 is attached to the window frame 2. However, a disposition of the antenna 30 is not limited to the region above the defogger 20, and may be disposed in a region below the defogger 20. The antenna 30 includes a feeding portion 31 and an antenna element 32 electrically connected to the feeding portion 31. A gap of dimension D1 is formed between the antenna 30 (a lower end of the antenna element 32) and the defogger 20 (an uppermost portion of the heater wires 22). The dimension D1 is, for example, 30 mm or more.

The antenna 30 shown in FIG. 1 is a diversity antenna. The antenna 30 includes a first antenna 30A disposed on the left side and a second antenna 30B disposed on the right side in a region above the defogger 20 of the glass plate 10. The first antenna 30A and the second antenna 30B have a left-right symmetrical structure. Therefore, in the following description, a structure of the first antenna 30A will be described, and description of a structure of the second antenna 30B will be omitted to avoid redundancy. Note that, the structures of the first antenna 30A and the second antenna 30B are not limited to being left-right symmetrical, and may be different from each other. Also, the antenna 30 does not have to be a diversity antenna, and in such a case, either the first antenna 30A or the second antenna 30B may be omitted.

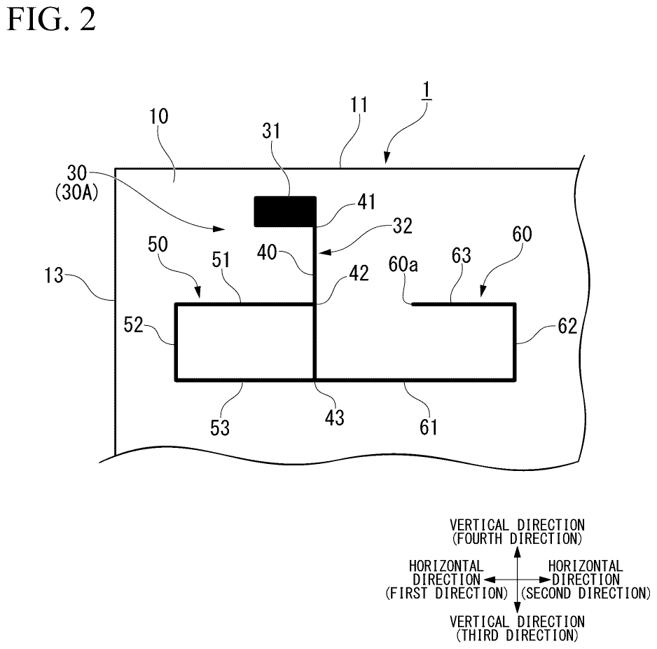

FIG. 2 is an enlarged plan view showing the antenna 30 according to the first embodiment of the present invention. In the following, a leftward horizontal direction is defined as a first direction, a rightward horizontal direction as a second direction, a downward vertical direction as a third direction, and an upward vertical direction as a fourth direction. Note that, the definitions of the first direction, the second direction, the third direction, and the fourth direction correspond to the first antenna 30A. In definition of directions for the second antenna 30B, the definitions of the first direction and the second direction are reversed.

Also, the first direction has an absolute value of an angle θ1 with respect to the horizontal direction, which may include 0°≤θ1≤15°, may be in a range of 0°≤θ1≤10°, may be in a range of 0°≤θ1≤5°, may be in a range of 0°≤θ1≤3°, or may be θ1=0°. When the angle θ1 at which the first direction extends approaches to 0°, a design appearance of the antenna 30 is improved. The second direction also is similarly defined.

The third direction has an absolute value of an angle θ2 with respect to the vertical direction, which may include 0°≤θ2≤15°, may be in a range of 0°≤θ2≤10°, may be in a range of 0°≤θ2≤5°, may be in a range of 0°≤θ2≤3°, or may be θ2=0°. When the angle θ2 at which the third direction extends approaches to 0°, the design appearance of the antenna 30 is improved. The fourth direction also is similarly defined.

The feeding portion 31 has, for example, a conductor pattern formed in a rectangular shape. The feeding portion 31 is electrically connected to one end of a power feed line (not shown in the drawings). Note that, a shape of the feeding portion 31 may be other shapes such as a circular shape or other polygonal shapes. In FIG. 1, the feeding portion 31 is disposed at a position close to the upper edge 11 on the side of the left edge 13 of the glass plate 10.

The antenna element 32 is electrically connected to the feeding portion 31. The antenna element 32 includes a first vertical element 40 extending in the vertical direction and a loop shape connected to the first vertical element 40. The antenna element 32 includes a first loop element 50 and a first folded-back element 60. The first loop element 50 is provided on one side in the horizontal direction (on the side in the first direction) with respect to the first vertical element 40. The first folded-back element 60 is connected to the first vertical element 40. The first folded-back element 60 extends toward the other side in the horizontal direction (on the side in the second direction) with respect to the first vertical element 40 and has a horizontally folded-back shape.

The first loop element 50 and the second folded-back element 60 are disposed on both sides of the first vertical element 40 to sandwich the first vertical element 40 in the horizontal direction. Therefore, a dimension of the antenna element 32 does not become larger on only one side in the horizontal direction with respect to the first vertical element 40.

The first vertical element 40 is a linear conductor pattern extending in the third direction from a lower right corner of the feeding portion 31. The first vertical element 40 includes a first contact portion 41, a second contact portion 42, and a third contact portion 43. The first contact portion 41 is provided at an end part of the first vertical element 40 in the fourth direction. At the first contact portion 41, the feeding portion 31 and the end part of the first vertical element 40 in the fourth direction are connected.

The second contact portion 42 is provided at an intermediate portion of the first vertical element 40. The intermediate portion of the first vertical element 40 may be any portion excluding both end parts of the first vertical element 40, and preferably refers to a middle region obtained when the entire length of the first vertical element 40 is divided into three equal parts. At the second contact portion 42, the first vertical element 40 and one end part of the first loop element 50 (first element 51) are connected.

The third contact portion 43 is provided at an end part of the first vertical element 40 in the third direction. At the third contact portion 43, the first vertical element 40 is connected to the other end part of the first loop element 50 (third element 53) and one end part of the first folded-back element 60 (fourth element 61). The first loop element 50 and the first folded-back element 60 do not extend below the third contact portion 43, thereby allowing performance to be achieved within a compact antenna area in the vertical direction.

The first loop element 50 is connected to the first vertical element 40 and has a loop shape. Here, the term “loop shape” means that it only needs to be formed as a closed loop, and may not only be a loop shape formed with the same line width, but also a loop shape having a part with a larger line width. A shape of the first loop element 50 may be, for example, a circular shape such as a circle, a substantially circular shape, an ellipse, or a substantially ellipse, or a rectangular or polygonal shape such as a square, a substantially square shape, a rectangle, a substantially rectangular shape, a parallelogram, a substantially parallelogram, a diamond, or a substantially diamond shape.

The first loop element 50 shown in FIG. 2 includes the first element 51, a second element 52, and the third element 53. The first element 51 extends in the first direction from the first vertical element 40. The second element 52 extends in the third direction away from the feeding portion 31 from an end part of the first element 51 in the first direction. The third element 53 extends in the second direction from an end part of the second element 52 in the third direction and is connected to the first vertical element 40.

Specifically, the first element 51 is connected to the second contact portion 42. The first element 51 is a linear conductor pattern that extends in the first direction from the second contact portion 42. The second element 52 is connected to the end part of the first element 51 in the first direction. The second element 52 is a linear conductor pattern that extends in the third direction from the end part of the first element 51 in the first direction.

The third element 53 is connected to the end part of the second element 52 in the third direction. The third element 53 is a linear conductor pattern that extends in the second direction from the end part of the second element 52 in the third direction. An end part of the third element 53 in the second direction is connected to the third contact portion 43. That is, the third element 53 is connected to the end part of the first vertical element 40 in the third direction.

One end part of the first folded-back element 60 is connected to the third contact portion 43 similarly to the third element 53. On the other hand, the other end part of the first folded-back element 60 is not connected to the first vertical element 40 and serves as an open end 60a. The first folded-back element 60 has a conductor pattern having the open end 60a and formed in a half-loop shape. The half-loop shape includes shapes such as a U shape, a C shape, a J shape, or an L shape in a plan view showing the glass plate 10.

The first folded-back element 60 shown in FIG. 2 includes the fourth element 61, a fifth element 62, and a sixth element 63. The fourth element 61 extends in the second direction from the first vertical element 40. The fifth element 62 extends in the fourth direction from an end part of the fourth element 61 in the second direction. The sixth element 63 extends in the first direction from an end part of the fifth element 62 in the fourth direction. In this way, the first folded-back element 60 has a horizontally folded-back shape. Therefore, it is possible to achieve performance within a compact antenna area in the horizontal direction.

Specifically, the fourth element 61 is connected to the third contact portion 43. The fourth element 61 is a linear conductor pattern that extends in the second direction from the third contact portion 43. The fifth element 62 is connected to the end part of the fourth element 61 in the second direction. The fifth element 62 is a linear conductor pattern that extends in the fourth direction from the end part of the fourth element 61 in the second direction. The fifth element 62 is provided to have the same length as the second element 52, but may have a different length. When the fifth element 62 and the second element 52 have the same length, the design appearance is improved.

The sixth element 63 is connected to the end part of the fifth element 62 in the fourth direction. The sixth element 63 is a linear conductor pattern that extends in the first direction from the end part of the fifth element 62 in the fourth direction. An end part of the sixth element 63 in the first direction is disposed with a gap in the horizontal direction with respect to the first vertical element 40. That is, the end part of the sixth element 63 in the first direction is the open end 60a.

In the antenna element 32 configured as described above, a shortest path length from the first contact portion 41 to the open end 60a (a total length of the first vertical element 40, the fourth element 61, the fifth element 62, and the sixth element 63) can be designed to receive radio waves in, for example, FM broadcast waves (76 MHz to 108 MHz), which is a first frequency band. When the shortest path length of the antenna element 32 is defined as L, and when the antenna 30 receives radio waves of FM broadcast waves (76 MHz to 108 MHz), it is preferable that the following relational expression (1) be satisfied, where a wavelength in air is λ, and a wavelength shortening coefficient of the glass plate 10 is k.

$$0.5 \times ( 1 / 4 ) \times λ \times k \leq L \leq 2. \times ( 1 / 4 ) \times λ \times k \qquad ( 1 )$$

Also, it is more preferable that the shortest path length L of the antenna element 32 satisfy the following expression (2).

$$0.75 \times ( 1 / 4 ) \times λ \times k \leq L \leq 1.5 \times ( 1 / 4 ) \times λ \times k \qquad ( 2 )$$

Also, in the antenna element 32, a longest path length from the first contact portion 41 to the open end 60a when passing through the first loop element 50 can be designed to receive radio waves in, for example, Band III of the DAB standard, which is a second frequency band. The longest path length is a total length from the first contact portion 41 to the second contact portion 42, including the first element 51, the second element 52, the third element 53, the fourth element 61, the fifth element 62, and the sixth element 63.

In this case, similarly to the above-described relational expressions (1) and (2), when the longest path length of the antenna element 32 is set to approximately (¼)×λ×k of the wavelength of the second frequency band, the antenna 30 can be made to have a wide bandwidth with a plurality of resonance points.

As described above, the vehicle window glass 1 of the present embodiment includes the glass plate 10 and the antenna 30 formed on the glass plate 10 and capable of receiving radio waves in a predetermined frequency band. The antenna 30 includes the feeding portion 31 and the antenna element 32 electrically connected to the feeding portion 31. In a plan view in a state in which the glass plate 10 is attached to the window frame 2, when a direction parallel to the horizontal plane is defined as a horizontal direction and a direction perpendicular to the horizontal direction is defined as a vertical direction, the antenna element 32 includes the first vertical element 40 electrically connected to the feeding portion 31, and extending in the vertical direction, the first loop element 50 connected to the first vertical element 40 to have a loop shape, and provided on one side in the horizontal direction (on the side in the first direction) with respect to the first vertical element 40, and the first folded-back element 60 connected to the first vertical element 40, and extending toward the other side in the horizontal direction (on the side in the second direction) with respect to the first vertical element 40 to have a folded-back shape. According to this configuration, the antenna pattern with the shortest path length from the first contact portion 41 to the open end 60a can receive radio waves in the first frequency band such as FM broadcast waves (76 MHz to 108 MHz), and the antenna pattern with the longest path length from the first contact portion 41 to the open end 60a via the first loop element 50 can receive radio waves in the second frequency band such as Band III (174 MHz to 240 MHz) of the DAB standard or the like, or can be adjusted to receive FM broadcast radio waves (76 MHz to 108 MHz) of the first frequency band over a wide bandwidth having a plurality of resonance points. Therefore, it is possible to provide the vehicle window glass 1 that can receive radio waves of a predetermined frequency band with a desired gain.

Also, in the present embodiment, the first loop element 50 includes the first element 51 extending from the first vertical element 40 to one side in the horizontal direction (first direction), the second element 52 extending from an end part of the first element 51 on one side in the horizontal direction to one side in the vertical direction (third direction) away from the feeding portion 31, and a third element 53 extending from an end part of the second element 52 on one side in the vertical direction to the other side in the horizontal direction (second direction) and connected to the first vertical element 40.

Also, in the present embodiment, the third element 53 is connected to an end part of the first vertical element 40 on one side in the vertical direction (third direction).

Also, in the present embodiment, the first folded-back element 60 is connected to the contact point (third contact point 43) between the first vertical element 40 and the third element 53.

Furthermore, in the present embodiment, the first folded-back element 60 includes the fourth element 61 extending from the first vertical element 40 to the other side in the horizontal direction (second direction), the fifth element 62 extending from an end part of the fourth element 61 on the other side in the horizontal direction to the other side in the vertical direction (fourth direction) close to the feeding portion 31, and the sixth element 63 extending from an end part of the fifth element 62 on the other side in the vertical direction to one side in the horizontal direction (first direction).

When the above-described configuration is provided, the vehicle window glass 1 can achieve performance within a compact antenna area in both the vertical and horizontal directions.

### Second Embodiment

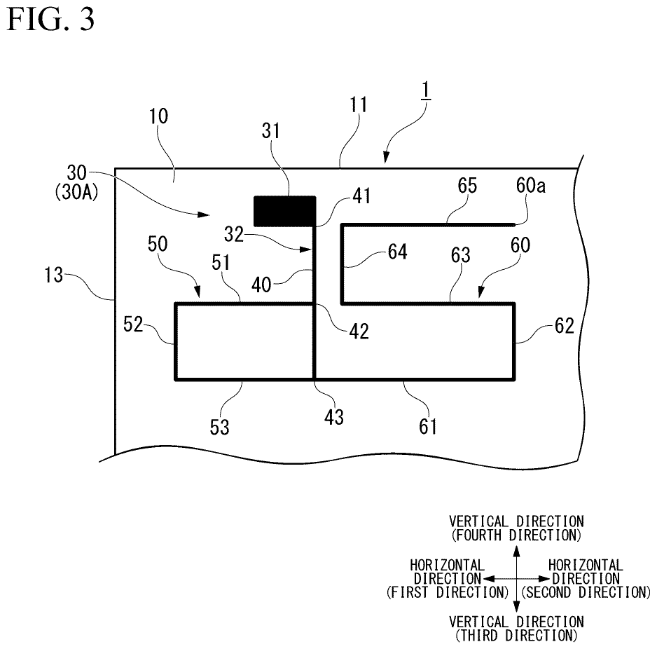

FIG. 3 is an enlarged plan view showing an antenna 30 according to a second embodiment of the present invention. In the following, as in the first embodiment, a leftward horizontal direction is defined as a first direction, a rightward horizontal direction as a second direction, a downward vertical direction as a third direction, and an upward vertical direction as a fourth direction, and third to eighth embodiments to be described later will also be described on the basis of the same definitions. Note that, in FIG. 3 and FIGS. 4 to 10 to be described later, components the same as those in the above-described embodiment will be denoted by the same reference signs.

As shown in FIG. 3, a first folded-back element 60 of the second embodiment includes a seventh element 64 and an eighth element 65. The seventh element 64 extends from an end part of a sixth element 63 on one side in the horizontal direction to the other side in the vertical direction. The eighth element 65 extends from an end part of the seventh element 64 on the other side in the vertical direction to the other side in the horizontal direction.

Specifically, an end part of the sixth element 63 in the first direction is not the open end 60a, but is connected to the seventh element 64. The seventh element 64 is a linear conductor pattern that extends in the fourth direction from the end part of the sixth element 63 in the first direction. The seventh element 64 is provided to have the same length as a length from a first contact portion 41 to a second contact portion 42, but may have a different length. When the seventh element 64 has the same length as that from the first contact portion 41 to the second contact portion 42, a design appearance is improved.

The eighth element 65 is connected to an end part of the seventh element 64 in the fourth direction. The eighth element 65 is a linear conductor pattern that extends in the second direction from the end part of the seventh element 64 in the fourth direction. The eighth element 65 is provided to have the same length as the sixth element 63, but may have a different length. When the eighth element 65 and the sixth element 63 have the same length, the design appearance is improved. An end part of the eighth element 65 in the second direction is an open end 60a. According to the configuration described above, a length of the first folded-back element 60 can be adjusted by making the first folded-back element 60 meander.

### Third Embodiment

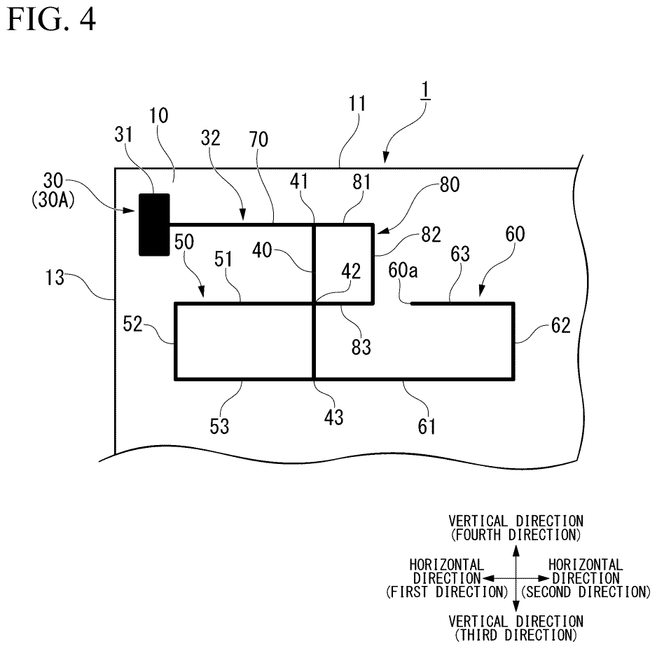

FIG. 4 is an enlarged plan view showing an antenna 30 according to a third embodiment of the present invention.

As shown in FIG. 4, an antenna element 32 of the third embodiment includes a lead-out element 70 and a second loop element 80. The lead-out element 70 extends in the horizontal direction from a feeding portion 31. The second loop element 80 is connected to a first vertical element 40 and has a loop shape. The second loop element 80 is provided on the other side in the horizontal direction (on the side in the second direction) with respect to the first vertical element 40.

The lead-out element 70 is a linear conductor pattern extending in the second direction from the feeding portion 31. The lead-out element 70 is connected to a first contact portion 41 of the first vertical element 40. According to this configuration, a degree of flexibility in disposition of the feeding portion 31 increases, and the feeding portion 31 can be disposed at a position, for example, close to a left edge 13 of a glass plate 10.

The second loop element 80 is connected to the first vertical element 40 and has a loop shape. The second loop element 80 shown in FIG. 4 includes a first element 81, a second element 82, and a third element 83. The first element 81 extends in the second direction from the first vertical element 40. The second element 82 extends in the third direction from an end part of the first element 81 in the second direction. The third element 83 extends in the first direction from an end part of the second element 82 in the third direction and is connected to the first vertical element 40.

Specifically, the first element 81 is connected to the first contact portion 41. The first element 81 is a linear conductor pattern that extends in the second direction from the first contact portion 41. The second element 82 is connected to the end part of the first element 81 in the second direction. The second element 82 is a linear conductor pattern that extends in the third direction from an end part of the first element 81 in the first direction.

The third element 83 is connected to the end part of the second element 82 in the third direction. The third element 83 is a linear conductor pattern that extends in the first direction from the end part of the second element 82 in the third direction. An end part of the third element 83 in the first direction is connected to a second contact portion 42. According to the configuration described above, since variations in the path length of the antenna element 32 increase, it is possible to provide the antenna 30 with a wide bandwidth having a plurality of resonance points.

### Fourth Embodiment

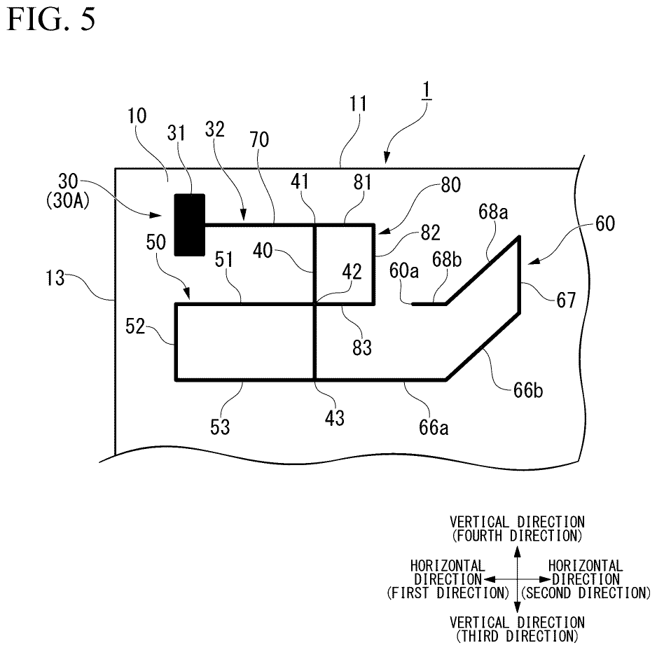

FIG. 5 is an enlarged plan view showing an antenna 30 according to a fourth embodiment of the present invention.

As shown in FIG. 5, a first folded-back element 60 of the fourth embodiment has a conductor pattern extending in an oblique direction.

The first folded-back element 60 includes a ninth element 66a, a tenth element 66b, an eleventh element 67, a twelfth element 68a, and a thirteenth element 68b. The ninth element 66a extends in the second direction from a first vertical element 40. The tenth element 66b extends from an end part of the ninth element 66a in the second direction, in an elevation-angle direction extending so as to approach the feeding portion 31 in the vertical direction with an increase in distance from the first vertical element 40. In the example shown in FIG. 5, the “elevation-angle direction” is an upward-inclined line extending diagonally upward to the right from the end part of the ninth element 66a in the second direction. The upward-inclined line is inclined at an acute angle with respect to the second direction and also inclined at an acute angle with respect to the fourth direction. In other words, the upward-inclined line has a directional component in the second direction and a directional component in the fourth direction. The eleventh element 67 extends in the fourth direction from an end part of the tenth element 66b in the elevation-angle direction. The twelfth element 68a extends from an end part of the eleventh element 67 in the fourth direction, in a depression-angle direction extending away from the feeding portion 31 in the vertical direction with a decrease in distance from the first vertical element 40. In the example shown in FIG. 5, the “depression-angle direction” is a downward-inclined line extending diagonally downward to the left from the end part of the eleventh element 67 in the fourth direction. The downward-inclined line is inclined at an acute angle with respect to the first direction and also inclined at an acute angle with respect to the third direction. In other words, the downward-inclined line has a directional component in the first direction and a directional component in the third direction. The thirteenth element 68b extends in the first direction from an end part of the twelfth element 68a in the depression-angle direction.

Specifically, the ninth element 66a is connected to a third contact portion 43. The ninth element 66a is a linear conductor pattern extending in the second direction from the third contact portion 43. The tenth element 66b is connected to the end part of the ninth element 66a in the second direction. The tenth element 66b is a linear conductor pattern that extends in the elevation-angle direction from the end part of the ninth element 66a in the second direction. Here, the elevation-angle direction refers to a direction with an angle θ3, in which, when the horizontal direction is defined as 0°, the angle θ3 may fall within a range of 15°<θ3<75°, may fall within a range of 20°≤θ3≤70°, may fall within a range of 30°≤θ3≤60°, may fall within a range of 40°≤θ3≤50°, or may be θ3=45°. When the angle θ3 in the elevation-angle direction approaches 45°, a design appearance of the antenna 30 is improved.

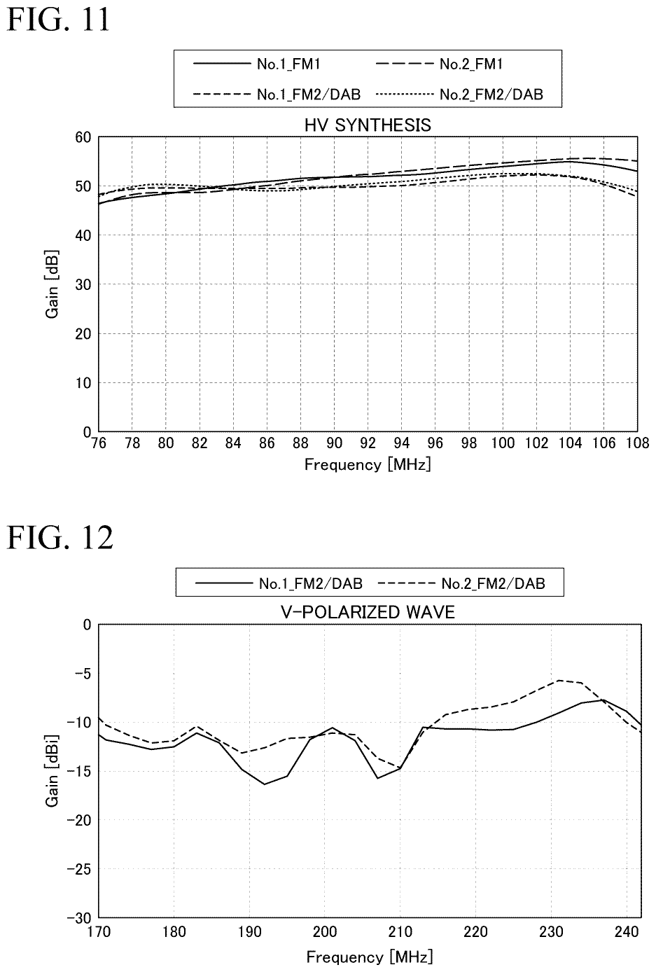

The eleventh element 67 is connected to the end part of the tenth element 66b in the elevation-angle direction. The eleventh element 67 is a linear conductor pattern that extends in the fourth direction from the end part of the tenth element 66b in the elevation-angle direction. Note that, in FIG. 5, the eleventh element 67 extends in the fourth direction, but it may extend in the first direction as shown in the folded-back shape of a first antenna 30A in FIG. 11 to be described later.

The twelfth element 68a is connected to the end part of the eleventh element 67 in the fourth direction. The twelfth element 68a is a linear conductor pattern that extends in the depression-angle direction from the end part of the eleventh element 67 in the fourth direction. Here, when the horizontal direction is defined as 0°, the depression-angle direction may be in a range of −15°<θ4<−75°, in a range of −20°≤θ4≤−70°, in a range of −30°≤θ4≤−60°, in a range of −40°≤θ4≤−50°, or θ4=−45°. When the angle θ4 in the depression-angle direction approaches −45°, the design appearance of the antenna 30 is improved.

The thirteenth element 68b is connected to the end part of the twelfth element 68a in the depression-angle direction. The thirteenth element 68b is a linear conductor pattern that extends in the first direction from the end part of the eleventh element 67 in the fourth direction. An end part of the thirteenth element 68b in the first direction is disposed with a gap in the horizontal direction with respect to a second loop element 80. That is, the end part of the thirteenth element 68b in the first direction is an open end 60a.

According to the configuration described above, even if a part of a defogger 20 has a shape protruding upward, an antenna element 32 can be disposed to follow the shape.

### Fifth Embodiment

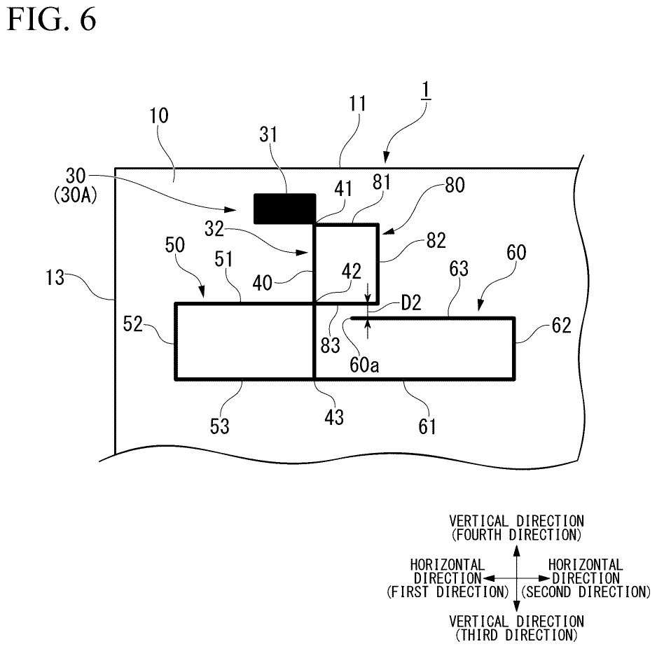

FIG. 6 is an enlarged plan view showing an antenna 30 according to a fifth embodiment of the present invention.

As shown in FIG. 6, in an antenna element 32 of the fifth embodiment, a sixth element 63 of a first folded-back element 60 is adjacent to a third element 83 of a second loop element 80 with a dimension D2 therebetween in the vertical direction. According to this configuration, the first folded-back element 60 and the second loop element 80 can be capacitively coupled, and a stable antenna gain can be achieved.

Furthermore, when the first folded-back element 60 and the second loop element 80 are capacitively coupled, the dimension D2 is preferably 30 mm or less, more preferably 25 mm or less, and still more preferably 20 mm or less. Also, the dimension D2 has no particular lower limit, but may be, for example, 1 mm or more, 3 mm or more, or 5 mm or more.

### Sixth Embodiment

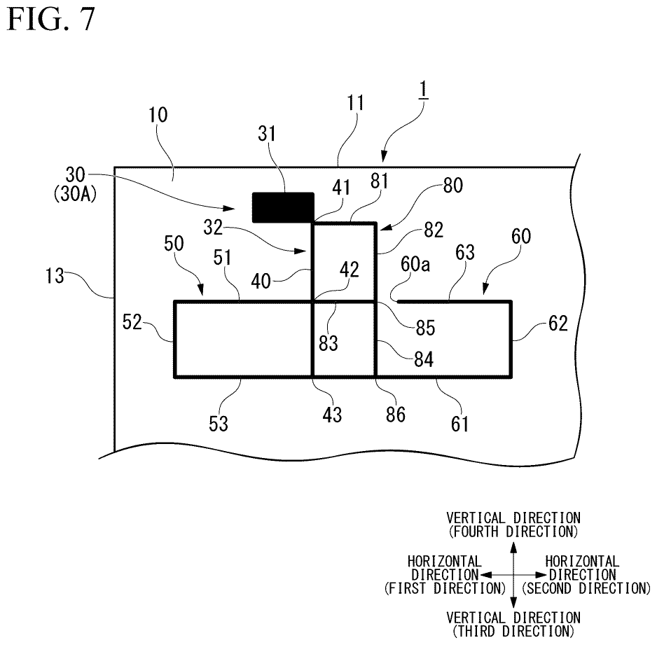

FIG. 7 is an enlarged plan view showing an antenna 30 according to a sixth embodiment of the present invention.

As shown in FIG. 7, in an antenna element 32 of the sixth embodiment, a second loop element 80 includes a connection element 84 that connects to a first folded-back element 60.

The connection element 84 is a linear conductor pattern that extends in the third direction from a connection portion between a second element 82 and a third element 83 of the second loop element 80. The connection element 84 includes a fourth contact portion 85 and a fifth contact portion 86. The fourth contact portion 85 is provided at an end part of the connection element 84 in the fourth direction. At the fourth contact portion 85, an end part of the second element 82 in the third direction and an end part of the third element 83 in the second direction of the second loop element 80 are connected.

The fifth contact portion 86 is provided at an end part of the connection element 84 in the third direction. At the fifth contact portion 86, the end part of the connection element 84 in the third direction and a fourth element 61 of the first folded-back element 60 are connected. When the end part of the connection element 84 in the third direction is connected to the fourth element 61 of the first folded-back element 60, the second loop element 80 forms two closed loops. Therefore, since variations in the path length of the antenna element 32 further increase, it is possible to provide the antenna 30 with a wide bandwidth having a plurality of resonance points.

### Seventh Embodiment

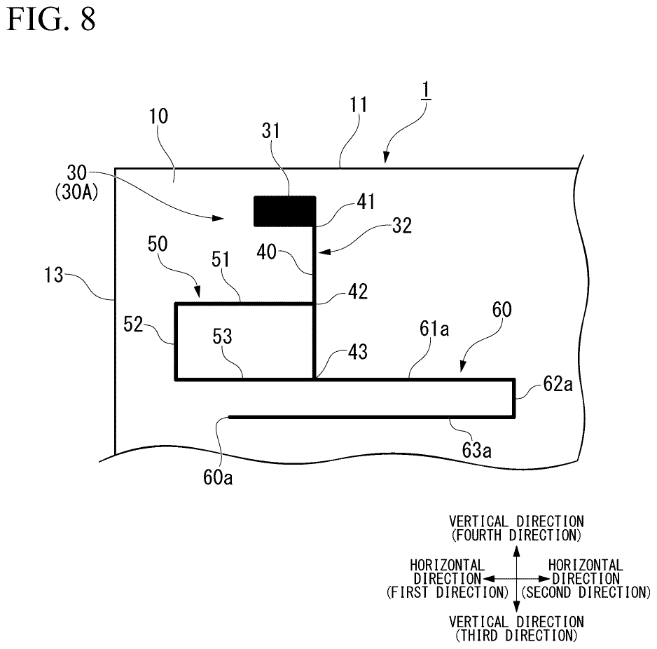

FIG. 8 is an enlarged plan view showing an antenna 30 according to a seventh embodiment of the present invention.

As shown in FIG. 8, a first folded-back element 60 of the seventh embodiment includes a fourth element 61a, a fifth element 62a, and a sixth element 63a. The fourth element 61a extends in the second direction from a third contact point 43 of a first vertical element 40. The fifth element 62a extends in the third direction from an end part of the fourth element 61a in the second direction. The sixth element 63a extends in the first direction from an end part of the fifth element 62a in the third direction. When there is a room in an antenna area in the vertical direction, the first folded-back element 60 may extend to a side opposite to a feeding portion 31 and be folded back as shown in FIG. 8.

### Eighth Embodiment

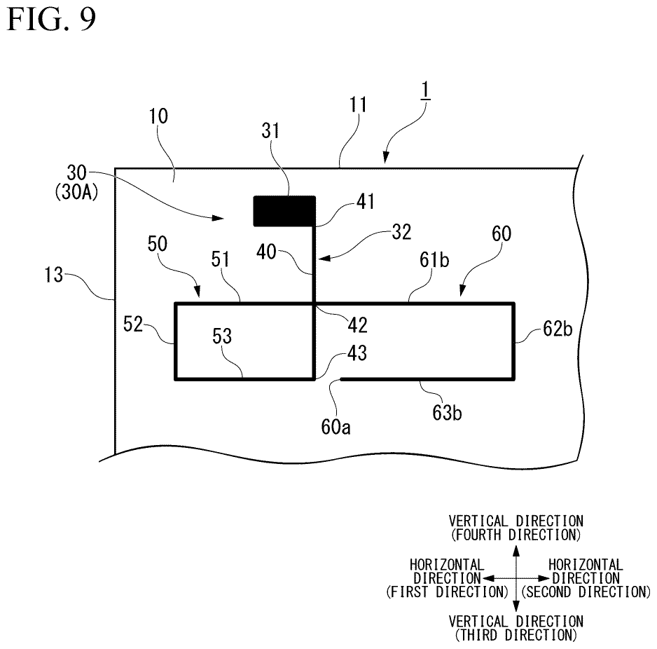

FIG. 9 is an enlarged plan view showing an antenna 30 according to an eighth embodiment of the present invention.

As shown in FIG. 9, a first folded-back element 60 of the eighth embodiment is connected to a second contact portion 42 of a first vertical element 40. The first folded-back element 60 of the eighth embodiment includes a fourth element 61b, a fifth element 62b, and a sixth element 63b. The fourth element 61b extends in the second direction from the second contact point 42 of the first vertical element 40. The fifth element 62b extends in the third direction from an end part of the fourth element 61b in the second direction. The sixth element 63b extends in the first direction from an end part of the fifth element 62b in the third direction. In this manner, the first folded-back element 60 may be connected to the second contact portion 42.

Although the vehicle window glass according to the embodiments of the present invention has been described above, the present invention is not limited to the above-described embodiments, and can be freely changed within the scope of the present invention. For example, some or all of each embodiment may be implemented in combination.

### EXAMPLES

Effects of the present invention will become apparent by the following examples. Note that, the present invention is not limited to the following examples, and can be implemented with appropriate modifications within a range not changing the gist thereof.

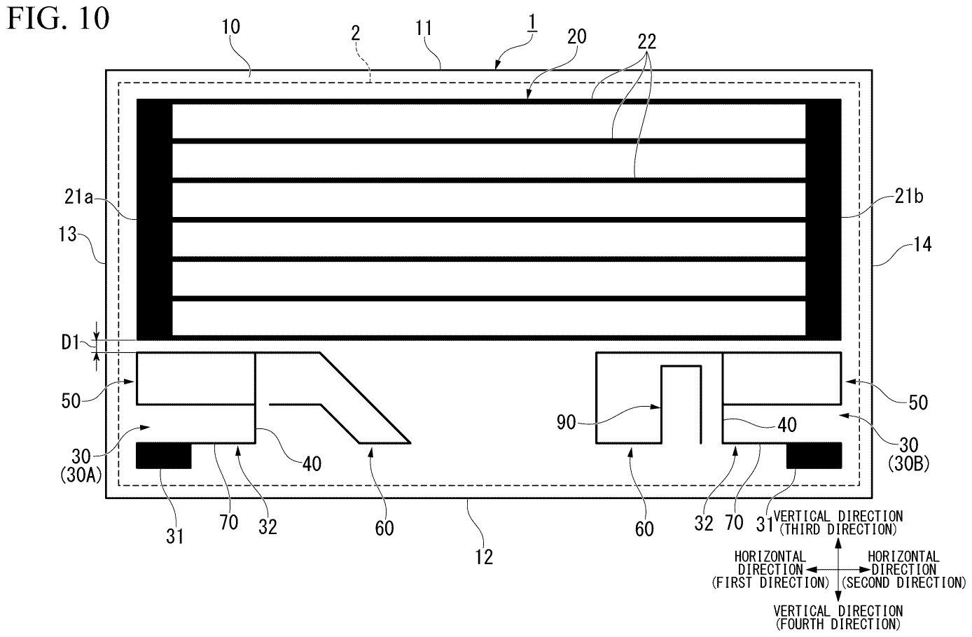

FIG. 10 is a plan view showing a vehicle window glass 1 according to one embodiment of the present invention. The vehicle window glass 1 of one example includes the above-described antenna 30 in a region below the defogger 20. In the example, since a shape of the antenna 30 is inverted in the vertical direction compared to those of the above-described embodiments, a leftward horizontal direction is defined as a first direction, a rightward horizontal direction as a second direction, a downward vertical direction as a fourth direction, and an upward vertical direction as a third direction.

Furthermore, a first antenna 30A has a configuration substantially similar to that of the fourth embodiment. The first antenna 30A includes a portion in which a first folded-back element 60 extends in an oblique direction. A second antenna 30B includes a second folded-back element 90 connected to a first folded-back element 60 and having a folded-back shape in the vertical direction. When the second folded-back element 90 folded back in the vertical direction is provided in this manner, a path length of the antenna element 32 may be adjusted.

FIG. 11 is a graph showing actual measurement results of antenna gains in a predetermined frequency band of the vehicle window glass 1 according to one example of the present invention. In FIG. 11, the horizontal axis represents a frequency [MHz] and the vertical axis represents a gain [dB]. Also, “No. 1” refers to the first antenna 30A disposed on the side of the left edge 13 of the glass plate 10. “No. 2” refers to the second antenna 30B disposed on the side of the right edge 14 of the glass plate 10.

Also, “H” indicates horizontally polarized waves, and “V” indicates vertically polarized waves. In FIG. 11, a gain [dB] obtained by combining the horizontally polarized waves and the vertically polarized waves is indicated as “HV synthesis”. “FM1” indicates a gain when only FM broadcast waves are received, and “FM2/DAB” indicates a gain when two frequency bands of FM broadcast waves and Band III of the DAB standard are received. Referring to FIG. 11, it was possible to ascertain that both the first antenna 30A and the second antenna 30B had high antenna gains (reception gains) for the frequency band of FM broadcast waves and for the two frequency bands of the FM broadcast waves and Band III of the DAB standard.

FIG. 12 is a graph showing actual measurement results of antenna gains in a predetermined frequency band of the vehicle window glass 1 according to one example of the present invention. Note that, FIG. 12, unlike FIG. 11, has the vertical axis representing a gain [dBi], and indicates a gain of only vertically polarized waves as “V-polarized waves”.

Referring to FIG. 12, it was possible to ascertain that the antenna gain of vertically polarized waves was high for both the first antenna 30A and the second antenna 30B. Therefore, it was possible to ascertain that reception with a desired gain could be achieved for Band III of the DAB standard.

As described above, according to the above example, it was possible to provide the vehicle window glass 1 that can receive radio waves of desired (two different) frequency bands with a desired gain.

In addition, the components in the above-described embodiments can be appropriately replaced with well-known components within a range not departing from the spirit of the present invention.

For example, the antenna 30 may have a ground portion. Therefore, the antenna 30 serves as a so-called dipole antenna having a feeding portion 31 (HOT side) and the ground portion (earth side). Note that, a ground element may extend in a predetermined direction from the ground portion.

For example, the respective numbers in the first to thirteenth elements, the first to fifth contact portions, and the like distinguish the respective components. The respective numbers may be increased or decreased, or appropriately reassigned depending on the purpose.

What is claimed is:

1. A vehicle window glass comprising:
a glass plate; and
an antenna formed on the glass plate and capable of receiving radio waves of a predetermined frequency band, wherein
the antenna includes:
a feeding portion; and
an antenna element electrically connected to the feeding portion,
when a direction parallel to a horizontal plane is defined as a horizontal direction, and a direction perpendicular to the horizontal direction is defined as a vertical direction in a plan view in a state in which the glass plate is attached to a window frame,
the antenna element includes:
a first vertical element electrically connected to the feeding portion and extending in the vertical direction;
a first loop element connected to the first vertical element to have a loop shape and provided on one side in the horizontal direction with respect to the first vertical element; and
a first folded-back element connected to the first vertical element and extending toward the other side in the horizontal direction with respect to the first vertical element to have a folded-back shape.

2. The vehicle window glass according to claim 1, wherein
the first loop element includes:
a first element extending from the first vertical element to one side in the horizontal direction;
a second element extending from an end part of the first element on one side in the horizontal direction to one side in the vertical direction away from the feeding portion; and
a third element extending from an end part of the second element on one side in the vertical direction to the other side in the horizontal direction to be connected to the first vertical element.

3. The vehicle window glass according to claim 2, wherein
the third element is connected to an end part of the first vertical element on one side in the vertical direction.

4. The vehicle window glass according to claim 2, wherein
the first folded-back element is connected to a contact point between the first vertical element and the third element.

5. The vehicle window glass according to claim 2, wherein
the first folded-back element includes:
a fourth element extending from the first vertical element to the other side in the horizontal direction;
a fifth element extending from an end part of the fourth element on the other side in the horizontal direction to the other side in the vertical direction close to the feeding portion; and
a sixth element extending from an end part of the fifth element on the other side in the vertical direction to one side in the horizontal direction.

6. The vehicle window glass according to claim 5, wherein
the first folded-back element includes:
a seventh element extending from an end part of the sixth element on one side in the horizontal direction to the other side in the vertical direction; and
an eighth element extending from an end part of the seventh element on the other side in the vertical direction to the other side in the horizontal direction.

7. The vehicle window glass according to claim 2, wherein
the first folded-back element includes:
a ninth element extending from the first vertical element to the other side in the horizontal direction;
a tenth element extending from an end part of the ninth element on the other side in the horizontal direction, in an elevation-angle direction extending so as to approach the feeding portion in the vertical direction with an increase in distance from the first vertical element;
an eleventh element extending from an end part of the tenth element in the elevation-angle direction to the other side in the vertical direction or to one side in the horizontal direction;
a twelfth element extending from an end part of the eleventh element on the other side in the vertical direction or on one side in the horizontal direction, in a depression-angle direction extending away from the feeding portion in the vertical direction with a decrease in distance from the first vertical element; and
a thirteenth element extending from an end part of the twelfth element in the depression-angle direction to one side in the horizontal direction.

8. The vehicle window glass according to claim 1, comprising a lead-out element extending in the horizontal direction from the feeding portion, wherein
the first vertical element is connected to the lead-out element.

9. The vehicle window glass according to claim 1, comprising a second loop element connected to the first vertical element to have a loop shape and provided on the other side in the horizontal direction with respect to the first vertical element.

10. The vehicle window glass according to claim 1, comprising a second folded-back element connected to the first folded-back element and having a folded-back shape in the vertical direction.

11. The vehicle window glass according to claim 1, wherein
the antenna is capable of receiving, as radio waves of the predetermined frequency band, radio waves of a first frequency band and radio waves of a second frequency band higher than the first frequency band.

12. The vehicle window glass according to claim 11, wherein
the first frequency band is a frequency band of FM broadcast waves.

13. The vehicle window glass according to claim 11, wherein
the second frequency band is a frequency band of Band III of the DAB standard.
